(19) United States
(12) Patent Application Publication
(10) Pub. No.: US 2021/0197498 A1
(43) Pub. Date: Jul. 1, 2021

(54) PARTICLE-FILAMENT COMPOSITE MATERIALS

(71) Applicant: THE TRUSTEES OF COLUMBIA UNIVERSITY IN THE CITY OF NEW YORK, New York, NY (US)

(72) Inventors: Ozgur SAHIN, New York, NY (US); Eran SCHENKER, New York, NY (US); Yocheved UNGAR, New York, NY (US); Onur CAKMAK, Mineola, NY (US)

(73) Assignee: THE TRUSTEES OF COLUMBIA UNIVERSITY IN THE CITY OF NEW YORK, New York, NY (US)

(21) Appl. No.: 17/187,135

(22) Filed: Feb. 26, 2021

Related U.S. Application Data
(63) Continuation of application No. PCT/US2019/048840, filed on Aug. 29, 2019.
(60) Provisional application No. 62/724,348, filed on Aug. 29, 2018.

(51) Int. Cl. B29C 70/02; B29C 70/88; B29C 70/30

(52) U.S. Cl. CPC B29C 70/025; B29K 2105/0097; B29C 70/305; B29C 70/88

(57) ABSTRACT

Systems and methods for developing a composite material are disclosed. The system can include a plurality of particles and a plurality of filaments. The plurality of particles can generate mechanical force in response to changing relative humidity, and the plurality of filaments can transfer the mechanical force throughout the composite material.

### CROSS-REFERENCE TO RELATED APPLICATIONS

This application is a continuation of International Patent Application No. PCT/US2019/048840, filed Aug. 29, 2019 which claims priority to U.S. Provisional Patent Application Ser. No. 62/724,348, filed Aug. 29, 2018, which is hereby incorporated by reference in its entirety.

### GRANT INFORMATION

This invention was made with government support under grant number N00014-16-1-2449 awarded by the Office of Naval Research (ONR). The government has certain rights in the invention.

### BACKGROUND

Humidity gradients can be ubiquitous in nature. Since certain energy transfer in evaporation and condensation can occur on a molecular level with the breaking of hydrogen bonds that bind water molecules together, it can be challenging to capture this energy and utilize it in applications. Although certain polymeric materials can respond to humidity gradients, these materials can require complicated production processes, suffer from low power output, and therefore be unable to exert large forces necessary for certain applications.

Because of their complex nanoscale structure, certain biological systems can have properties which are not easily reproduced in synthetic materials. For example, certain bacterial spores can respond to changes in humidity by expanding and contracting, producing strains with corresponding energy densities (i.e., high energy density actuation) while retaining their stiffness and biological function. However, due to their granular nature, it can be difficult to assemble a continuous, large-scale material for energy applications from biological particles and spores.

Thus, there is a need for stimuli-responsive materials which can be developed at large scales, while meeting cost and technical performance needs.

### SUMMARY

The disclosed subject matter provides tunable composite materials which can generate mechanical force in response to changing relative humidity. In some embodiments, the disclosed subject matter provides a composite material that can include a plurality of particles and a plurality of filaments. The plurality of particles can generate mechanical force in response to changing relative humidity. The plurality of filaments can enmesh the plurality of particles and transfer the mechanical force throughout the composite material.

In certain embodiments, the plurality of particles can be a bacterial spore. For example, the bacterial spore can be Bacillus Subtilis wild type, Bacillus Subtilis CotE, Bacillus Subtilis GerE, Bacillus Thuringiensis wild type, and combinations thereof. The plurality of particles can expand and/or contract in response to the changing relative humidity. In non-limiting embodiments, the plurality of filaments includes a cellulose nanofiber. A surface property (e.g., hydrophobicity) of the plurality of filaments can be customized. In some embodiments, the composite material can include an adhesive. For example, the adhesive can be dopamine, a UV-curable adhesive, or a combination thereof. In non-limiting embodiments, the composite material can be porous.

The disclosed subject matter also provides methods of making composite materials which can generate mechanical force in response to changing relative humidity. An example method can include mixing a plurality of particles and a plurality of filaments to make a suspension and drying the suspension to produce the composite material. The plurality of particles can generate mechanical force in response to changing relative humidity. The plurality of filaments can enmesh the plurality of particles and transfer the mechanical force throughout the composite material. In non-limiting embodiments, the plurality of particles can include a bacterial spore. In some embodiments, the plurality of filaments includes cellulose nanofibers. The plurality of particles and the plurality of filaments are provided in a ratio of about 1:1 by weight in the suspension.

In certain embodiments, the method can further include spraying the suspension on a substrate. In non-limiting embodiments, the method can also include adding an adhesive. In some embodiments, the method can further include modifying a surface property of the plurality of filaments. In certain embodiments, the method can further include modifying a condition of the drying to alter a property of the composite material. The condition of the drying can include temperature, airflow speed, humidity, pressure, a dry rate, and combinations thereof. The surface property of the composite material can include young's Modulus, tear strength, tensile strength, yield strength, or combinations thereof.

### BRIEF DESCRIPTION OF THE DRAWINGS

Further features and advantages of the present disclosure will become apparent from the following detailed description taken in conjunction with the accompanying figures showing illustrative embodiments of the present disclosure, in which:

FIGS. 1A-B are images of (1A) an example particle composite sheet and (2) an example cutout of the particle composite sheet in accordance with the present disclosure.

FIG. 2 illustrates an exemplary procedure for preparing an example particle composite sheet in accordance with the present disclosure.

FIG. 3 is a graph illustrating the energy density versus strain of various stimuli-responsive materials in accordance with the disclosed subject matter.

FIG. 4A is an image of an example spore-cellulose nanofiber (CNF) film.

FIG. 4B is an SEM image of an example microstructure of the example spore-CNF film in accordance with the disclosed subject matter.

FIG. 5A is a graph illustrating the work/energy density of example spore-CNF films. FIG. 5B is a graph illustrating the work to water uptake ration of example spore-CNF films in accordance with the disclosed subject matter.

FIG. 6 is a graph illustrating a spore-CNF composite material's response to stress over 50 cycles.

FIG. 7A is a schematic setup for demonstrating energy generated by an example spore-CNF composite. FIG. 7B is an image of a setup for demonstrating energy generated by an example spore-CNF composite. FIG. 7C is an image illustrating changes of the vertical position of weight as a function of time.

FIG. 8A is an image of an example spore-cellulose nanofiber (CNF) film with a paper-like appearance. FIG. 8B is an SEM image of an example microstructure of the example spore-CNF film in accordance with the disclosed subject matter.

FIG. 9A is a graph illustrating work generated relative to the amount of water absorbed. FIG. 9B is a graph illustrating work density for CNF-only samples and spore/CNF samples with 1:1 mixing ratio by weight.

Throughout the figures, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments.

### DETAILED DESCRIPTION

The disclosed subject matter provides composite materials that can generate mechanical force in response to changing relative humidity and methods for making thereof.

An example composite material can include a plurality of particles and a plurality of filaments. The plurality of particles is linked to the plurality of filaments forming a stand-alone composite material that can inherit the properties of the particles.

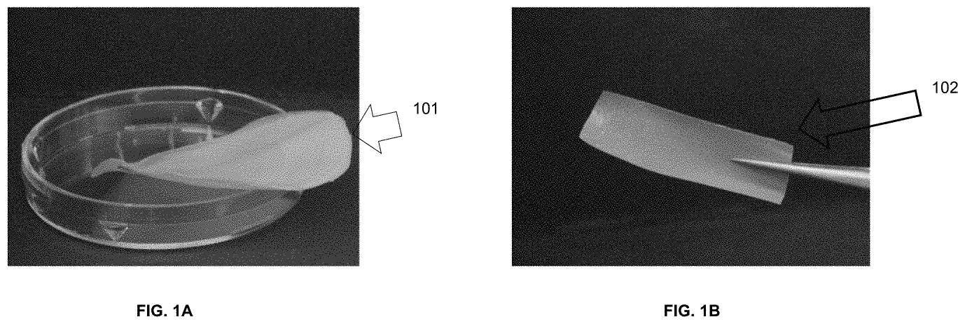

In non-limiting embodiments, as shown in FIG. 1, the composite material 101 can be a thin film 102. The composite material 101 can be porous and include channels that diffuse water throughout the composite material.

In certain embodiments, the plurality of particles can generate mechanical force in response to changing relative humidity. For example, the plurality of particles can expand and/or contract in response to the changing relative humidity. In non-limiting embodiments, the plurality of particles can be bacterial spores. The bacterial spores can include, for example, Bacillus Subtilis spores, cotE mutant of Bacillus Subtilis, gerE mutant of Bacillus Subtilis, Bacillus Thuringiensis spores, or combinations thereof. In some embodiments, the disclosed bacterial spores can be stiff structures (e.g., elastic modulus values on the order of 10 GPa) and respond to changes in humidity by expanding and contracting. In non-limiting embodiments, the disclosed spore can have a layered structure. For example, the disclosed spores can have a tensed cortex surrounded by a loosely adhered coat which can allow enables the spores to produce strains (e.g., up to about 11.7%) while retaining their stiffness and biological function. In certain embodiments, the disclosed spores can be tagged with fluorescent proteins or with molecules that introduce ascent to the spores. Other biological microparticles such as cells as well as inorganic microparticles like quantum dots and silver nanoparticles can be assembled into the composite material through the particles.

The term “about” or “approximately” means within an acceptable error range for the particular value as determined by one of ordinary skill in the art, which will depend in part on how the value is measured or determined, i.e., the limitations of the measurement system. For example, “about” can mean within three or more than three standard deviations, per the practice in the art. Alternatively, “about” can mean a range of up to 20%, preferably up to 10%, more preferably up to 5%, and more preferably still up to 1% of a given value. Also, particularly with respect to systems or processes, the term can mean within an order of magnitude, preferably within five-fold, and more preferably within two-fold, of a value.

In certain embodiments, the plurality of filaments can enmesh the plurality of particle and transfer the mechanical force generated by the particles throughout the composite material. In non-limiting embodiments, the plurality of filaments can include a cellulose nanofiber. A cellulose nanofiber (CNF) can be a bio-based material which can have high elastic moduli (e.g., up to about 150 GPa). The disclosed CNF can be also an abundant, environment-friendly material that can form durable films. The disclosed CNF can be about a nanometer wide (e.g., about 3-5 nm) and hundreds of nanometers long (e.g., up to about 1000 nm). In some embodiments, the disclosed CNF can be stiff and stable. The disclosed CNF also can adhere well to the spores and transfer of force generated by the particles throughout the spore-CNF composite material. In certain embodiments, the disclosed spore can be genetically modified. For example, the disclosed bacterial spores can be genetically modified by any known gene-editing techniques (e.g., Meganucleases, Zinc finger, TALEN, CRISPR, or MAGE).

In certain embodiments, certain properties of the plurality of filaments can be customized. For example, in order to increase the material's efficiency of converting humidity gradients into mechanical force, water can preferentially enter the spores rather than absorbing on to the filaments or settling in pores inside the material. The amount of water absorbed onto the filaments can be reduced by increasing their surface hydrophobicity. For decreasing to filaments' surface energy, cationic surfactants can be attached to the filaments carboxyl heads or employing EDC (1-Ethyl-3-(3-dimethylaminopropyl)carbodiimide) coupling to add an amine-containing molecule to their carboxylic group. In non-limiting embodiments, the disclosed composite material can contain species of bacterial spores with naturally hydrophobic coats so that the amount of water that settles onto surfaces of spores and in the gaps between spores can decrease. In some embodiments, the disclosed spores can be genetically engineered so that the hydrophobicity on the surface of the spores can increase.

In certain embodiments, the composite material can further include an adhesive. The tight binding of the disclosed particles to the disclosed filaments can increase the efficiency of energy transfer throughout the disclosed composite material. Introducing an adhesive can improve the binding of particles-filaments as well as filaments-filaments. In non-limiting embodiments, the adhesive can include dopamine, a UV curable adhesive, or a combination thereof. When oxidized under alkaline conditions, dopamine can polymerize into polydopamine that improves binding of fibers to spores and to themselves. The UV curable adhesive can include silver and water-insoluble.

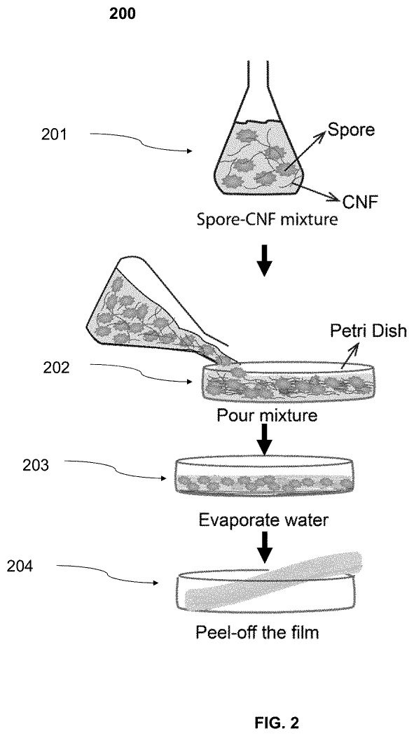

In certain embodiments, the disclosed subject matter also provides methods for making composite materials which can generate mechanical force in response to changing relative humidity. As show in FIG. 2, an example method 200 can include mixing a plurality of particles and a plurality of filaments to make a suspension 201 and drying the suspension to produce the composite material. The plurality of particles and a plurality of filaments can be suspended in various solutions (e.g., water). For example, a composite material can be prepared with a spore to CNF ratio (by weight) of 1. The relative amount of spores and CNF in the composite material can be adjusted in order to tailor the material properties for certain applications. For example, using a larger amount of spores can result in a material with a higher force response, while using fewer spores can result in a more robust and tear-resistant material. CNF can be suspended in water and homogenized 200. Bacterial spores of various strains (e.g., Bacillus Subtilis wild type, Bacillus Subtilis CotE GerE, and Bacillus Thuringiensis wild type) can be added, and the suspension can be homogenized and sonicated without damaging the mixture.

NaOH can be added to adjust a pH of the suspension and dissociate the carboxyl groups that decorate the surface of CNF. The mixture can be then poured into a petri dish 202 and cast-dried 203 and 204. In some embodiments, the pH of the suspension can be modified to alter filament-particle interaction. For example, the CNF can have carboxyl groups on their surfaces that are fully disassociated at high pH (>10). When dissociated, the fibers can carry a negative charge and they repel each other, enabling an even dispersion of spores amongst the fully disentangled fibers. In certain embodiments, the ratio of particles to filaments can be between about 1:1 and about 1:10, or between about 1:1 and about 3:1, by weight. For example, the plurality of particles and the plurality of filaments can be provided in a ratio of about 1:1 or 3:1 by weight. The ratio can be modified based on various applications. For example, the ratio of particles to filaments can be more than 1:10 to dilute the properties inherited from the particles. In non-limiting embodiments, the ratio of particles to filaments can be more than 3:1 to adjust the integrity of the disclosed materials.

In certain embodiments, the method can include drying the suspension. For example, the composite material can be made by cast drying a suspension of the particles and filaments. When dried, the filaments can self-assemble into a scaffolding that binds to the particles creating a continuous fabric-like material. As the drying rate of the suspension can alter the properties of the material, temperature, airflow speed, pressure, and relative humidity can be adjusted to control the drying rate. For example, in order to increase the packing density of the composite material, the suspension can be dried under pressure (e.g., vacuum filtration or a mechanical press). In certain embodiments, the method can further include adding an adhesive. An adhesive can be added to the suspension in order to improve the binding of the particles and the stiff filaments. The mechanical properties of the material (e.g., Young's Modulus, tear strength, tensile strength, and yield strength) can be improved by introducing plasticizers to the material.

In certain embodiments, the method can further include modifying a condition of the drying to alter a property of the composite material. The drying condition can include temperature, airflow speed, humidity, pressure, a dry rate, or combinations thereof. In non-limiting embodiments, the property of the composite material can include young's Modulus, tear strength, tensile strength, yield strength, or combinations thereof.

In certain embodiments, the method can further include spraying the suspension on a substrate. For example, the suspension itself can be used as a spray-on coating that can be applied to fabrics and materials in order to render them hygro-responsive. Such fabrics and materials can be used to control perspiration by controlling the evaporation rate of sweat through the fabric or material. Particle-filament suspensions can also be used as 3D printer ink and used to print custom three-dimensional structures that retain the microparticles' properties.

In certain embodiments, the suspension can be processed via extrusion and/or roll-to-roll processing. Such methods can be scaled up to an industrial level. For example, in the extrusion process, the suspension of particles and stiff filaments can be pushed through a thin slit die in order to form sheets. Once a sheet is formed, it can be further modified using a roll-to-roll processing method in which rollers can be used to pull continuously on the sheet in one direction. The Roll-to-roll processing can generate coatings that can alter the optical, mechanical and thermomechanical properties of the sheet. By adjusting the pressure during this process, sheets with thicknesses ranging from 1 micrometer to 1 mm can be produced. The roll-to-roll manufacturing process can also be used to apply a coating of the suspension to another sheet in order to introduce the properties of the particles to the substrate material or to coat the particle-filament composite material with protective layers such as breathable waterproof coatings.

In certain embodiments, the method can further include modifying a surface property of the plurality of filaments. For example, the CNF surfaces can be chemically modified in order to improve adhesion. 1-Ethyl-3-(3-dimethylaminopropyl)carbodiimide (EDC) coupling can be implemented in order to graft sulfo-NHS onto CNF that crosslinks amine groups to spore-coat proteins for improving CNF-spore binding. EDC and NHS can also be used to link 3rd party UV-radical cross-linkers such as Benzophenone (BP). For example, when the film is exposed to UV irradiation post-film preparation, BP can induce radical-based crosslinking that crosslinks fibers to themselves and entangles spores between them. This crosslinking can improve the tensile strength of the film under wet conditions. In non-limiting embodiments, a positively charged stiff filament (e.g. surface modified CNF with positive, instead of negative, surface charge) can be used to enable better spore-CNF adhesion as the spores can have a negative charge.

In certain embodiments, the disclosed composite material be further modified in order to tailor their functionality for various applications. For example, UV stabilizers can be added to the composite material to improve the service life of the material by preventing UV degradation. In-non limiting embodiments, post-drying processes can also be used to increase the utility of the material. For example, the composite material can be coated with protective layers like waterproof coatings that allow moisture transport but protect the material from water droplets (e.g., waterproof perforated films or breathable spray coatings).

In certain embodiments, the disclosed subject matter can be used for various applications. For example, smart materials that can reversibly respond to external stimuli can be used in various fields including robotics, medicine and sensing industry. The disclosed subject matter can have advantages over electrically powered hard actuators which require bulky wiring or heavy batteries. The spore-CNF composite material can function in and of itself as a humidity responsive actuator for soft robotic applications, as an adaptive stimuli-responsive textile and for adaptive architectures.

In certain embodiments, the mechanical force induced by humidity changes in the disclosed composite material can be used for energy applications and power generation. For example, the generated actuation energy can be converted into electrical energy by coupling spore-CNF material to a piezoelectric film to create a flexible energy harvester. The flexible energy harvester can be used as a power generator for flexible electronics or sensors. Because the human body produces sweat, this device can be used as a wearable, battery-less energy harvester or sensor. The disclosed material can also be used as the hygro-responsive material in hydration-based energy generators.

In certain embodiments, the disclosed composite material can be non-toxic and biodegradable. In non-limiting embodiments, the disclosed composite material can be recyclable. For example, the particles and filaments can be re-suspended in a solution and be reused.

### Example 1—Development of Particle-Filament Composite Materials

The presently disclosed subject matter will be better understood by reference to the following Example. The Example provided as merely illustrative of the disclosed methods and systems, and should not be considered as a limitation in any way. Among other features, the example illustrates an example particle-filament composite materials and methods of developing thereof.

Certain microscopic and nanoscopic particles can have characteristics which can be distinctive from large scale materials such as energy density actuation, antimicrobial properties, and tunable optical properties. For example, individual bacterial spores can respond to changes in humidity by expanding and contracting, producing strains of up to 11.7% with corresponding energy densities of 21.3 J/cm³. However, due to their granular nature, it can be challenging to assemble a continuous and large-scale material from microscopic particles. The disclosed subject matter can overcome this problem by linking together the microparticles with stiff filaments, such as cellulose nanofibers (CNF), which can bind to the microparticles to each other to form a stand-alone composite material that inherits the properties of the microscopic particles.

These particle-filament composite materials in FIGS. 1A and 1B can be produced by cast drying a suspension of the particles and stiff filament as shown in FIG. 2. When dried, the stiff filaments can self-assemble into a scaffolding that binds to and supports the particles, creating a continuous fabric-like material. The drying rate of the suspension can influence the nanoscale properties of the material. Temperature, airflow speed, and relative humidity can be adjusted to control the drying rate in order to optimize material characteristics. In order to increase the packing density of the material, the suspension can be dried under pressure using methods such as vacuum filtration or a mechanical press. Additionally, adhesives can be added to the suspension in order to improve the binding of the microparticles and the stiff filaments. The mechanical properties of the material (such as Young's Modulus, tear strength, tensile strength, and yield strength) can be improved by introducing plasticizers to the material. Instead of cast drying the suspension of particles and filaments, the suspension can be sprayed on to other substrates and used a coating. Particle-filament suspensions can also be used as 3D printer ink and used to print custom three-dimensional structures that retain the microparticles' properties.

Alternatively, the material can be manufactured using extrusion and roll-to-roll processing, methods that are easily scaled up to an industrial level. In the extrusion process, a viscous suspension of microparticles and stiff filaments can be pushed through a thin slit die in order to form sheets. Once a sheet is formed, it can be further modified using a roll-to-roll processing method in which rollers are used to pull continuously on the sheet in one direction. Roll-to-roll processing enables the application of treatments and coatings that can alter the optical, mechanical and thermomechanical properties of the sheet. By adjusting the pressure during this process, sheets with thicknesses ranging from 1 micrometer to 1 mm can be produced. The roll-to-roll manufacturing process can also be used to apply a coating of the suspension to another sheet to introduce the properties of the particles to the substrate material or to coat the particle-filament composite material with protective layers such as breathable waterproof coatings.

An example application of the above-mentioned material can be an actuating hydro or hygro-responsive material composed of hydro or hygro-responsive particles, such as bacterial spores, and stiff filaments, such as CNF. Smart materials, a new generation of materials that reversibly respond to external stimuli, can be an application for robotics, medicine, and sensing. The disclosed subject matter can provide certain advantages over certain electrically powered hard actuators which have limited mobility and are externally powered, requiring bulky wiring or heavy batteries. Certain stimuli-responsive materials can be metal or polymer-based and respond to changes in pH, temperature or light. Such stimuli are generated in unnatural settings, restricting the utility of these materials.

Because of their complex nanoscale structure, certain biological systems can have unique properties. For example, bacterial spores can be stiff structures (elastic modulus values on the order of 10 GPa) that respond to changes in humidity by expanding and contracting. The spore's unique layered structure of a tensed cortex surrounded by a loosely adhered, wrinkled coat enables the spores to produce strains of up to 11.7% while retaining their stiffness and biological function. The individual spore's energy density of up to 21.3 J/cm³ is unmatched in synthetic materials. Hygroscopic actuators made from coating a flexible substrate with spores can be used as actuators and for energy applications. Certain spore coated materials can exhibit only bending motion, due to their bilayer structure, which places design constraints on their applications. Furthermore, energy can be lost lifting the substrate material, reducing the efficiency of the material. Contact between spores can be limited so forces are transferred with losses through the material. At large scales, hydration kinetics can be slow, which increases response time and decreases the power of the material.

The disclosed subject matter can overcome such issues by creating a composite thin film of spores and stiff filaments that bind spores together using the methods described above. CNF, a bio-based material, can be stiff filaments to use to bind spores together because CNF is 3-5 nanometer wide, hundreds of nanometers long, and have elastic moduli of ˜150 GPa. CNF can adhere to spores and absorb the spore's force. CNF can also stiff and reduce its deformation. Due to such characteristics, CNF can transfer the force throughout the spore-CNF composite material. Furthermore, spore-CNF composite films can be thin (e.g., tens of microns thick) and naturally porous so that there can be channels within the material through which water can travel. Both of these factors can allow water to diffuse throughout the material.

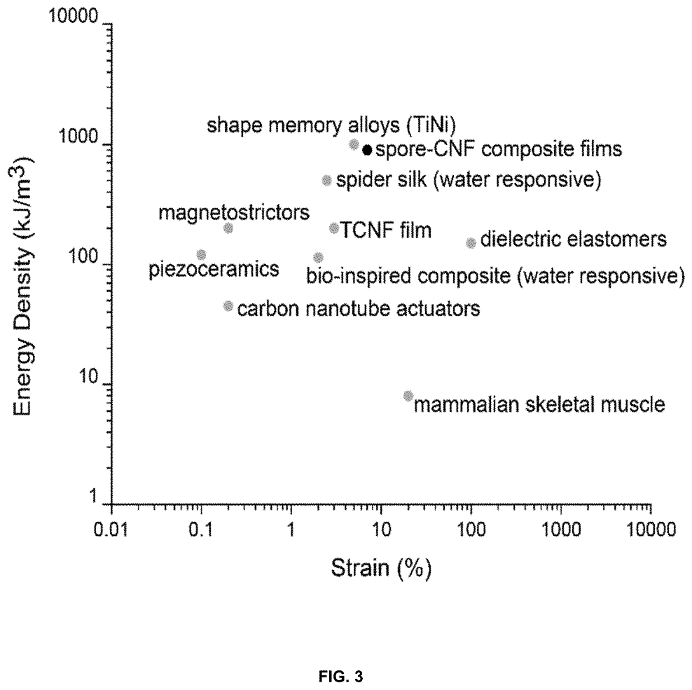

Samples prepared with a spore to CNF ratio (by weight) of 1 create films that inherit an energy density from the spores and the toughness and flexibility from CNF, as shown in FIG. 3. The relative number of spores and CNF in the composite material can be adjusted for specific applications. Spore-CNF films were prepared in the following manner: TEMPO oxidized (CNF) (University of Maine) was suspended in DDH2O at 1.1% wt/v and homogenized at 6 krpm (IKA Ultra Turrax T-18) for 5 minutes followed by at 4 krpm for 10 minutes. This two-procedure homogenization process was used because running the homogenizer only at high speed, at 6 krpm, for 15 minutes added excessive heat to the samples, which could damage the spore-CNF solution. CNF suspensions were sonicated for approximately 10 minutes. Bacterial spores of various strains (Bacillus Subtilis wild type, Bacillus Subtilis CotE GerE, and Bacillus Thuringiensis wild type) were added, and the suspension was homogenized and sonicated again. 50-150 ml of 10 M NaOH was added in 50 ml increments until the suspension had a pH of 10-12 because, at high pH (pH≥10), the carboxyl groups that decorate the surface of CNF are fully dissociated. Once fully dissociated, CNF carries negative charges and individual fibers are electrostatically repelled from one another, enabling the spores to be evenly dispersed amongst the fibers. The mixture was then poured into a petri dish and cast-dried. The drying rate of the sheets can influence their nanostructure. As water evaporates off the surface of a sample, humidity gradients can be created between the surface and center of the drying sheet. This humidity gradient can introduce stresses on the material that result in the deformation of the sheet, but drying samples in a humid environment can prevent these deformations from occurring.

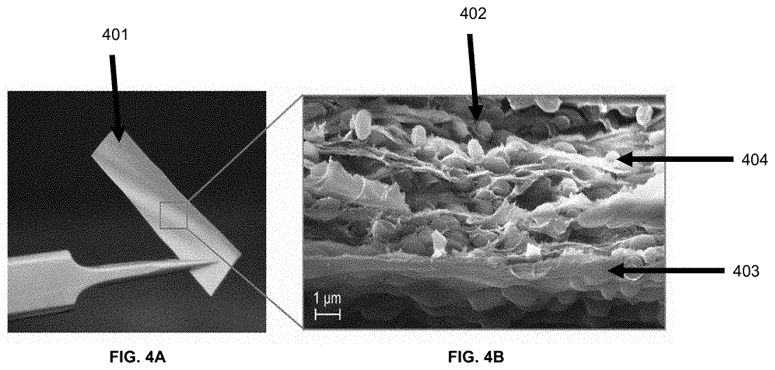

Samples were dried slowly in a humid environment (70% RH) so that the wrinkles and cracks present in sheets dried in a dry environment (20% RH) can be reduced. The film 401 was then peeled from the mold and cut into standard size (approximately 0.5 cm by 2 cm) strips for characterization as shown in FIG. 4A. Scanning electron microscopy (SEM) 402 of spore-CNF films confirms that CNF 403 enmeshes the spores 404 and links them to one another, as shown in FIG. 4B. Other spores to CNF ratios of 0.2 up to 5, by weight, can be used to create spore-CNF composite materials.

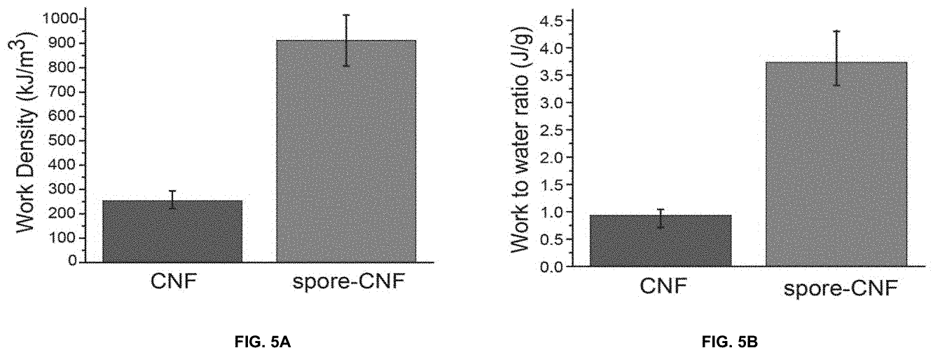

In order to quantify the humidity response of spore-CNF composite films, the isometric stress and the isotonic strain produced by the samples in response to changes in humidity was measured. The work density of the material can be approximated as the product of this stress and strain. Work density values for the spore-CNF samples are shown in FIG. 5A in comparison to films of pure CNF films.

Certain characteristics of a hygroscopic material can be its efficiency of converting latent heat into work. The amount of water absorbed and released by a material can be proportional to the latent heat required for water to condense and evaporate on and off the material. Therefore, the ratio of mechanical work output to the amount of water absorbed and released during actuation can be used to quantify the material's efficiency of converting latent heat into actuation. The work to water ratio of spore-CNF materials is shown in FIG. 5B in comparison to a pure CNF film.

In addition to their hydro-responsive performance, spore-CNF materials can be used for various applications because they are non-toxic and biodegradable. Spore-CNF films can be also recyclable. For example, they can be re-suspended in water and reused.

CNF can be stiff filaments, and CNF surface chemistry can be modified, enabling customization for different applications. In order to increase the material's efficiency of converting humidity gradients into actuation, water can preferentially enter the spores rather than absorbing on to the stiff filaments or settling in pores inside the material. For example, the amount of water absorbed into the CNF can be reduced by increasing their hydrophobicity. Certain methods, including attaching cationic surfactants to CNF carboxyl heads or employing EDC (1-Ethyl-3-(3-dimethylaminopropyl)carbodiimide) coupling to add an amine-containing molecule to their carboxylic group, can be used to decrease the surface energy of the fibers. Additionally or alternatively, films can contain species of bacterial spores with naturally hydrophobic coats so that the amount of water that settles onto surfaces of spores and in the gaps between spores can be decreased. Similarly, spores can be genetically engineered so that the hydrophobicity on the surface of the spores is increased.

Packing of microparticles and binding of microparticles to the stiff filaments leads to the efficient transfer of forces throughout a hygro-responsive material. This can be achieved with the disclosed methods. For example, introducing adhesives can improve CNF-spore as well as CNF-CNF binding. One such adhesive can be dopamine that, when oxidized under alkaline conditions, polymerizes into polydopamine that improves the binding of fibers to spores and to themselves.

Also, CNF surfaces can be chemically modified in order to improve adhesion. For example, EDC coupling can be implemented to graft sulfo-NHS onto CNF that crosslinks amine groups to spore-coat proteins for improved CNF-spore binding. EDC and NHS can also be used to link 3rd party UV-radical cross-linkers such as Benzophenone (BP). When the film is exposed to UV irradiation post-film preparation, BP can induce radical-based crosslinking that crosslinks fibers to themselves and entangles spores between them. This crosslinking can improve the tensile strength of the film under wet conditions. Thirdly, a positively charged stiff filament (e.g. surface modified CNF with positive, instead of negative, surface charge) can be used to enable better spore-CNF adhesion as the spores have a slight negative charge.

Other methods that can be employed to improve the material include adjusting the pH of the suspension to alter filament-particle interaction. For example, as discussed earlier, CNF can have carboxyl groups on their surfaces that are fully disassociated at high pH (>10). When dissociated, the fibers carry a negative charge and they repel each other, enabling an even dispersion of spores amongst the fully disentangled fibers.

Microparticle-filament composite materials can be further modified to tailor functionality for real-world situations. For instance, UV stabilizers can be added to the material to improve the service life of the material by preventing UV degradation. Post-drying processes can also be used to increase the utility of the material. Hygroscopic materials can be coated with protective layers like waterproof coatings that allow moisture transport but protect the film from water droplets, such as with waterproof perforated sheets or films or with breathable spray coatings.

The hygro-responsive material described above has many diverse applications. The spore-CNF composite material can function in and of itself as a humidity responsive actuator for soft robotic applications, as an adaptive stimuli-responsive textile and for adaptive architectures. Because spore-CNF composite materials have increased energy density but are soft and flexible, they can be used for delicate tasks and applications such as prosthetics.

In addition to creating actuating stand-alone materials from suspensions of hygro-responsive materials and filaments, the suspension itself can be used as a spray-on coating that can be applied to fabrics and materials to render them hygro-responsive. Such fabrics and materials can be used to control perspiration by controlling the evaporation rate of sweat through the fabric or material.

Furthermore, the actuation induced by humidity changes in the hygroscopic material can be harnessed for energy applications and power generation. For example, the actuation energy can be converted into electrical energy by coupling spore-CNF material to a piezoelectric film to create a flexible energy harvester that can be used as a power generator for flexible electronics and for sensors. Because the human body produces sweat, this device can be used as a wearable, battery-less energy harvester or sensor. This material can also be used as the hygro-responsive material in hydration-based energy generators.

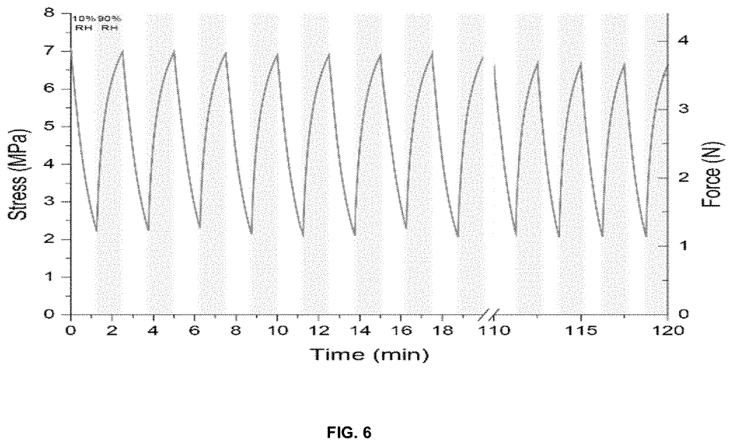

In order to be useful as an actuator, materials can deform reversibly and repeatedly. CNF-spore samples were exposed to two and a half minute cycles of high (90% relative humidity (RH)) and low humidity (10% RH) and the force generated by the sample was measured, as shown in FIG. 6. The sample response was nearly unchanged after 50 cycles. The spore-CNF films are robust and do not lose integrity over time, which makes them optimal for actuator applications.

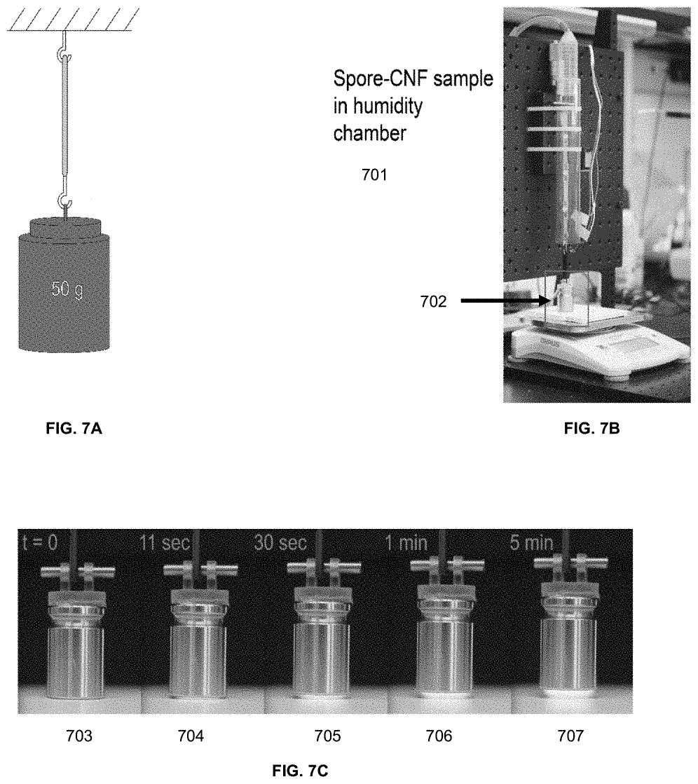

The ability of the spore-CNF films 701 to perform useful work was demonstrated by attaching a 50 g weight 702 to a sample weighing 42 mg in FIGS. 7A-C. Upon reducing the humidity from 90% RH to 10%, the sample exerted a force 0.532 N and lifted a load more than 1,000 times its own weight within 11 seconds 703-704. Within 5 minutes, the sample had lifted the weight a distance 2.14 mm 703-707, as shown in FIGS. 7A-C.

In addition to hygroscopic materials, genetic engineering can be utilized to introduce novel functionality to spores, and in turn, to fabrics containing the spores. For instance, spores can be tagged with fluorescent proteins or with molecules that introduce ascent to the spores. Other biological microparticles such as cells as well as inorganic microparticles like quantum dots and silver nanoparticles can be assembled into material using these methods.

### Example 2—Standalone Spore-Based Sheets for Evaporation Drive Energy Harvesters

The presently disclosed subject matter will be better understood by reference to the following Example. The Example provided as merely illustrative of the disclosed methods and systems and should not be considered as a limitation in any way. Among other features, the example illustrates architectures for evaporation-driven active materials.

Certain bacterial spores can have energy densities which makes them be used for actuator applications. However, creating tough macroscopic materials form spores can pose challenges. In order to transmit the mechanical force from one spore to another, and between layers of spores, spores can be required to adhere to each other with a stiff and ductile material. Otherwise, spores can slip across each other during expansion and contraction, or cracks can occur within the active layer due to stress.

The disclosed subject matter can provide techniques to combine spores with UV curable adhesives to develop an actuator with increased energy and power densities. The adhesives can be water-insoluble which enables water-resistant hygroscopic actuators. The disclosed subject matter also provides an actuator device which can respond to liquid water and/or moist air with enough power density for various applications.

The disclosed subject matter also provides techniques to improve adhesion between spores, which can be used to develop spore-based standalone materials. The developed materials showed improved energy conversion with linear expansion and contractions. For example, spores can be combined with Cellulose Nano Fibers (CNF). CNF is an abundant, environment-friendly material that can form durable films. The film-forming capabilities of CNFs and humidity responsive behavior of the spores were combined in the disclosed humidity responsive standalone sheets. The disclosed spore/CNF sheets can exhibit approximately 4-fold better work output compared to the CNF-only sheets, which exhibit certain humidity responsiveness due to the hydrophilic nature of CNF.

Incorporating adhesives improved the integrity of the spore-based materials; however, this approach can work when a mixture of spores and adhesives are applied as a coating to flexible substrates and the coating is susceptible to crack formation. The coating-based approach can limit the use of spore-based materials to bilayer systems and can reduce the amount of energy that can be delivered to an external load (e.g., a generator or the moving arm of a robot). In addition, actuation can be achieved by changes in curvature, rather than linear expansion and contraction, which results in substantial design constraints.

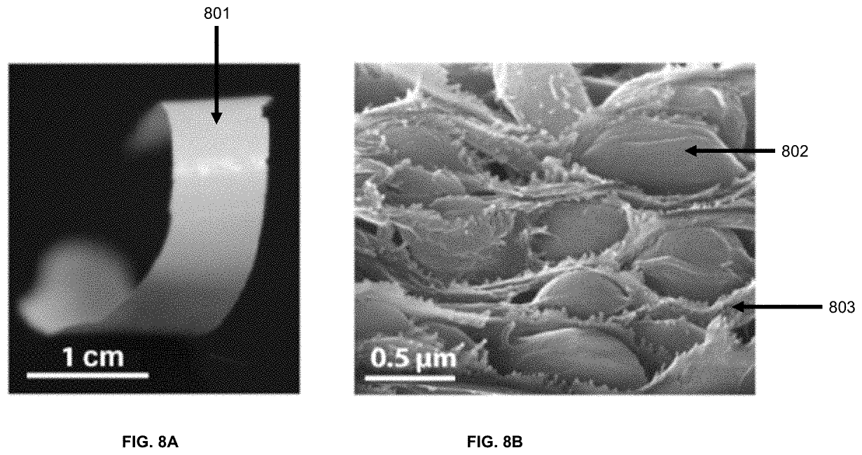

To achieve broader exploitation of spores' energy conversion and actuation capabilities, various capabilities of combining bacterial spores and cellulose nanofibers (CNFs, also known as nano-cellulose) were tested to develop a new class of composite materials that inherit unique energy conversion capabilities of spores along with the tensile strength of CNFs. FIG. 8 shows example mixtures of spores and cellulose nanofibers that can yield novel actuator materials. A spore/nano-cellulose composite sheet 801 in FIG. 8A is approximately 38 microns thick and has a paper-like appearance. FIG. 8B shows a nano- to microscale structure of the spore 802/nano-cellulose 803 sheets.

The disclosed cellulose nanofibers showed an improved tensile strength. A composite material made of spores and cellulose nanofibers also exhibited an improved tensile strength due to the fibers and an improved work density actuation capability due to spores. The disclosed cellulose nanofibers were served as a paper-like scaffold that can give the material its macroscopic integrity. The disclosed spores were served as the “muscles” that contract and expand in response to changes in relative humidity.

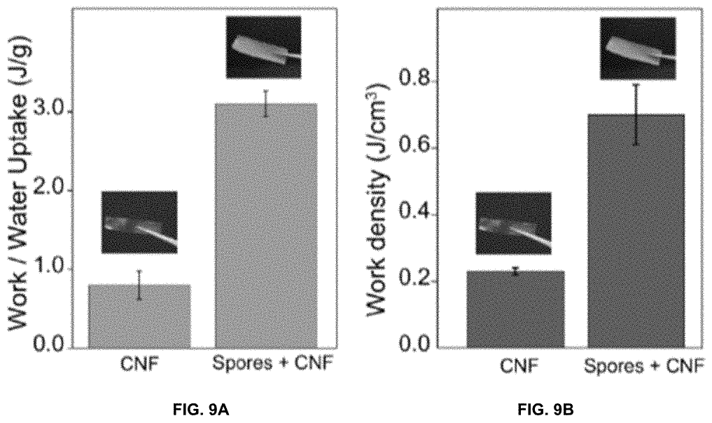

The disclosed spore/CNF sheets were prepared using a method illustrated in FIG. 2. After dispersing CNFs in water, CNFs were mixed with spores with varying mixing ratios. The resulting mixture was dried in a container and then peeled off. FIGS. 1A and 1B show spore/CNF sheets prepared in this way using 1:1 by weight spore/CNF mixture. One of the functional characteristics of a humidity responsive material can be the ratio of the mechanical work output to the amount of water absorbed or released during the actuation process. This ratio can be used to determine the efficiency of the energy conversion process because evaporation of water requires a supply of latent heat, which scales with the amount of water involved. A group of eight samples demonstrated approximately 4 times better work-to-water ratio compared to the CNF-only samples (FIGS. 9A and 9B). The CNF component of spore/CNF samples contributed to water absorption without contributing to the work output. Accordingly, the CNF content in the spore/CNF sheets can be modified to improve the work-to-water ratio substantially.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein.

The foregoing description of specific embodiments of the disclosed subject matter has been presented for purposes of illustration and description. It is not intended to be exhaustive or to limit the disclosed subject matter to those embodiments disclosed. It will be apparent to those skilled in the art that various modifications and variations can be made in the methods and systems of the disclosed subject matter without departing from the spirit or scope of the disclosed subject matter. Thus, it is intended that the disclosed subject matter include modifications and variations that are within the scope of the appended claims and their equivalents.

What is claimed is:

1. A composite material comprising:
a plurality of particles configured to generate mechanical force in response to a changing relative humidity; and
a plurality of filaments enmeshed the plurality of particles and configured to transfer the mechanical force throughout the composite material.

2. The composite material of claim 1, wherein the plurality of particles comprises a plurality of bacterial spores.

3. The composite material of claim 2, wherein the bacterial spores are selected from the group consisting of Bacillus Subtilis wild type, Bacillus Subtilis CotE, Bacillus Subtilis GerE, Bacillus Thuringiensis wild type, and combinations thereof.

4. The composite material of claim 1, wherein the plurality of particles are configured to expand or contract in response to the changing relative humidity.

5. The composite material of claim 1, wherein the plurality of filaments comprises a plurality of cellulose nanofibers.

6. The composite material of claim 1, wherein a surface property of the plurality of filaments is configured to be customized.

7. The composite material of claim 6, wherein the surface property is hydrophobicity.

8. The composite material of claim 1, further comprising an adhesive.

9. The composite material of claim 10, wherein the adhesive is dopamine.

10. A method for fabricating a composite material, comprising:
mixing a plurality of particles and a plurality of filaments to make a suspension, wherein the plurality of particles is configured to generate mechanical force in response to a changing relative humidity; and
drying the suspension to produce the composite material, wherein the plurality of filaments is enmeshed the plurality of particles and configured to transfer the mechanical force to the composite material.

11. The method of claim 10, further comprising spraying the suspension on a substrate.

12. The method of claim 10, further comprising adding an adhesive.

13. The method of claim 10, further comprising modifying a surface property of the plurality of filaments.

14. The method of claim 10, further comprising modifying a condition of the drying to alter a property of the composite material.

15. The method of claim 14, wherein the condition is selected from the group consisting of: temperature, airflow speed, humidity, pressure, a dry rate, and combinations thereof.

16. The method of claim 14, wherein the property of the composite material includes young's Modulus, tear strength, tensile strength, yield strength, or combinations thereof.

17. The method of claim 10, wherein the plurality of particles comprises a plurality of bacterial spores.

18. The method of claim 10, wherein the plurality of filaments comprises a plurality of cellulose nanofibers.

19. The method of claim 10, wherein the plurality of particles and the plurality of filaments are provided in a ratio of about 1:1 by weight.

20. The method of claim 10, wherein the plurality of particles and the plurality of filaments are provided in a ratio of about 3:1 by weight.
